(19) United States
(12) Patent Application Publication
(10) Pub. No.: US 2008/0250658 A1
(43) Pub. Date: Oct. 16, 2008

(54) Compass with Leg Joint and Information Bearing Surfaces

(75) Inventor: Gunther Partes, Emskirchen (DE)

Correspondence Address: LERNER GREENBERG STEMER LLP, P O BOX 2480, HOLLYWOOD, FL, 33022-2480, US

(73) Assignee: INTERTECH ZEICHENGERATE GMBH, Emskirchen (DE)

(21) Appl. No.: 12/102,339

(22) Filed: Apr. 14, 2008

(30) Foreign Application Priority Data
Apr. 12, 2007 (DE) DE102007017558.4

(51) Int. Cl. B43L 9/02

(52) U.S. Cl. 33/27.02

(57) ABSTRACT

A compass includes a leg joint and two compass legs provided at lower ends with holders for refills or styluses and articulated with one another at upper ends. An adjusting spindle penetrates the compass legs, in particular in the vicinity of the leg joint. The compass legs are respectively provided with a carrier zone, in particular as a widening, that serves in the region between the leg joint and the free leg ends as a base of an information bearing surface surpassing the width of the compass legs in their spreading plane. The information bearing surface is disposed on at least one of the two broad sides of the compass and is constructed as an undivided surface that projects from one leg into the region of the other leg and permits the opening and closing of the legs without a gap or interspace being formed in the information bearing surface.

### CROSS-REFERENCE TO RELATED APPLICATION

This application claims the priority, under 35 U.S.C. §119, of German Patent Application DE 10 2007 017 558.4, filed Apr. 12, 2007; the prior application is herewith incorporated by reference in its entirety.

### BACKGROUND OF THE INVENTION

Field of the Invention

The invention relates to a compass including a leg joint through which two compass legs, provided at their lower ends with holders for refills or styluses, are connected to one another at their upper ends in a jointed manner, preferably with the aid of an adjusting spindle provided in the vicinity of the leg joints and penetrating the compass legs. The legs are respectively provided with a carrier zone, in particular in the form of a widening, that serves in the region between the leg joint and the free leg ends as a base of an information bearing surface extending over, in particular surpassing, the width of the compass legs in their spreading plane.

Such a compass is known from German Utility Model DE 20 2005 013 280 U1. In that case, a gap between the two compass legs divides the information bearing surface into two halves that form a practically closed surface only when the limbs lie against one another.

### SUMMARY OF THE INVENTION

It is accordingly an object of the invention to provide a compass with a leg joint and information bearing surfaces, which overcomes the hereinafore-mentioned disadvantages of the heretofore-known devices of this general type and in which an information bearing surface remains an undivided surface without regard to whether or not the compass is spread open.

With the foregoing and other objects in view there is provided, in accordance with the invention, a compass, comprising two broad sides, two legs having upper ends and free lower ends, holders disposed at the free lower ends of the legs for holding refills or styluses, and a leg joint interconnecting the upper ends of the legs for articulation in a spreading plane, preferably with the aid of an adjusting spindle penetrating the legs in the vicinity of the leg joint. The legs each have a respective carrier zone, preferably in the form of a widening of the legs, serving, in a region between the leg joint and the free lower ends of the legs, as a base of an information bearing surface with a greater width in the spreading plane than the legs. The information bearing surface is disposed on at least one of the two broad sides and is constructed as an undivided surface projecting from one of the legs into the vicinity of the other of the legs and permitting opening and closing of the legs without a gap or interspace being formed in the information bearing surface.

The advantages that can be attained with the aid of the invention are primarily that the information bearing surface is a closed surface and also remains so whether or not the compass legs are spread open. Depending on the selected display on the information bearing surface, for example advertising, small works of art, decorative elements or mathematical formulas, a gap can no longer disturb the latter.

Other features which are considered as characteristic for the invention are set forth in the appended claims.

Although the invention is illustrated and described herein as embodied in a compass with a leg joint and information bearing surfaces, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF SEVERAL VIEWS OF THE DRAWING

FIG. 1 is a diagrammatic, front-elevational view of a first exemplary embodiment of a drawing compass having its legs in a closed position and an information bearing surface having a shape resembling a circle;

FIG. 2 is a front-elevational view of the embodiment according to FIG. 1 with its legs spread open and a rear mounting disk for the information bearing surface that is made visible thereby;

FIGS. 3 and 4 are front-elevational views of a second exemplary embodiment in illustrations corresponding to FIGS. 1 and 2, with a difference being that a refill leg has no additional joint;

FIG. 5 is a front-elevational view of a third exemplary embodiment of a compass in which one mounting disk each for the information bearing surface is attached in a congruent double configuration on front and rear sides of a left-hand compass leg (in which a rear mounting disk is not shown);

FIG. 6 is a front-elevational view of the embodiment according to FIG. 5 in a closed position of the compass legs; and

FIGS. 7 and 8 are front-elevational views of a fourth exemplary embodiment in illustrations corresponding to FIGS. 5 and 6, with a difference being that the refill leg has no additional joint.

### DETAILED DESCRIPTION OF THE INVENTION

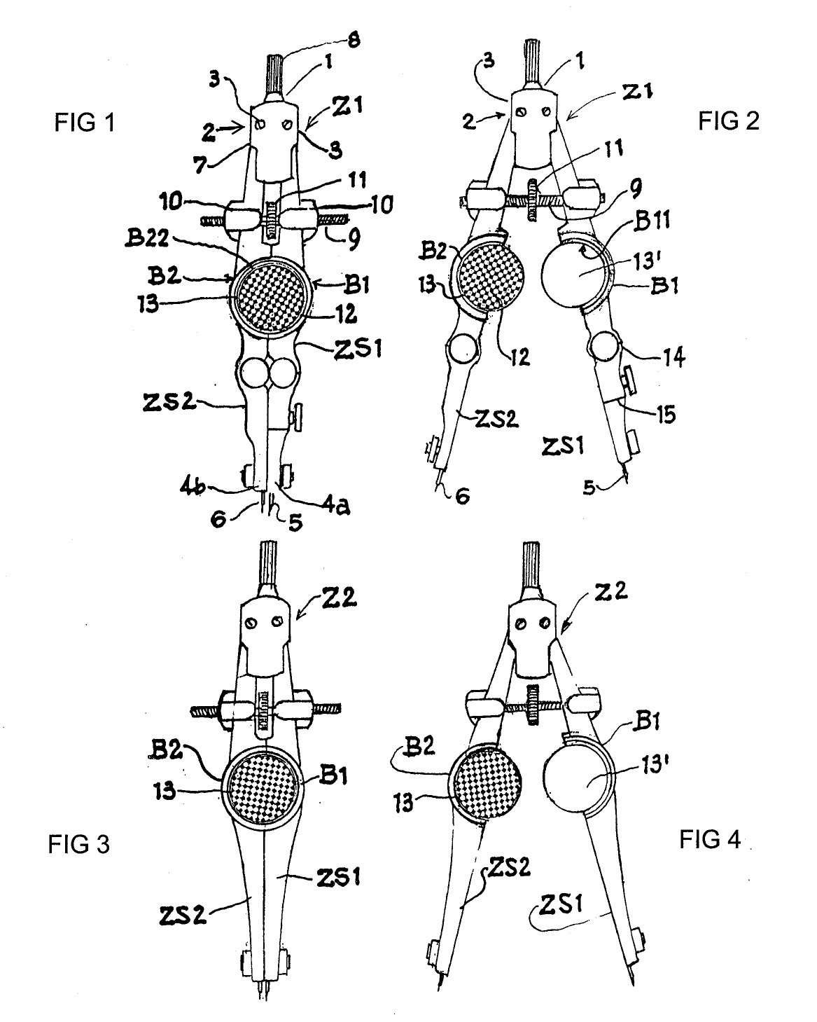

Referring now to the figures of the drawings in detail and first, particularly, to FIGS. 1 and 2 thereof, there is seen a compass Z1 having a head 1, below which a leg joint 2 having two joint or head screws 3 can be seen. The latter are used to interconnect upper ends of two compass legs ZS1, ZS2 in a jointed manner. The compass legs ZS1, ZS2 are provided at their lower ends with holders 4a, 4b for a refill or lead 5 or a stylus 6. A joint plate 7 and a similar non-illustrated, oppositely-disposed joint plate are permanently connected to the head 1 and a knurled cylinder 8 adjoins the latter. Like compasses Z2, Z3, Z4 according to FIGS. 3 to 8, which will be described below, the compass Z1 is preferably provided with an adjusting spindle 9 provided in the vicinity of the leg joint 2 and penetrating the compass legs ZS1, ZS2. The spindle 9 is rotatably supported on spindle bearings 10 fastened on the legs ZS1, ZS2, and a knurled wheel 11, which is seated on the spindle 9 in the middle between the compass legs, enables the compass legs ZS1, ZS2 to be spread open or placed together by being rotated in one direction of rotation or the other.

The legs ZS1, ZS2 are each provided with a respective carrier zone B1, B2, in particular in the form of a widening that serves, in a region between the leg joint 2 (preferably between the adjusting spindle 9) and free ends of the legs, as a base of an information bearing surface 12 extending over, in particular surpassing, the width of the compass legs in their spreading plane. The information bearing surface has a checkered pattern, as a general example. As mentioned at the beginning, the information bearing surface can be configured to be informative or decorative, in a non-illustrated manner.

According to the invention, the information bearing surface 12 is provided on at least one of the two broad sides of the compass Z1 and forms the leg ZS2 as an undivided surface that projects into the region of the other leg ZS1 and permits the legs to be opened and closed without a gap or interspace being formed in the information bearing surface 12.

As illustrated, the information bearing surface 12 can have a circular shape. However, it can also, in particular, be a regular polygon, for example a quadrilateral or hexagon, or have the non-illustrated shape of an ellipse.

In this example, the information bearing surface 12 is attached to a mounting disk 13 (see FIG. 2) that, for its part, is fastened on a semicircular support surface B22 in the region of the carrier zone or leg widening B2. One mounting disk 13 is attached to the front side of one leg ZS2, and another mounting disk 13′ (not shown in FIG. 1) is attached to the rear of the other leg ZS1 at a support surface B11 which is seen in FIG. 2 with the compass open. The right-hand leg ZS1 is provided with a lockable joint 14, while a lower end of the leg ZS1 is further connected to a remainder of the leg (see parting line 15) in such a way that it can be exchanged. An underside of the mounting disk 13′, seen in FIG. 2, could likewise be provided with an information bearing surface.

In the example according to FIGS. 1 and 2, the information bearing surface 12 is fastened as a printed film on the respective mounting disk, in particular bonded onto the latter. However, it is also advantageous to print a printed image of the information bearing surface 12 directly onto the mounting disk 13, 13′. A further structure coming into consideration is for the mounting disk 13, 13′ to be cast onto the respective compass leg, for which purpose it is formed of the same material, preferably diecast zinc. In accordance with a simpler construction, the mounting disk is formed of plastic. In the case of a separate construction of the mounting disk made from metal, the disk can be formed of aluminum or, for example, of diecast zinc. A more valuable construction is distinguished in that the mounting disk 13, 13′ is formed of imprintable coin metal and is provided with an imprint serving the purpose of information and/or decoration.

According to a further embodiment, the mounting disk 13, 13′ is provided with a coat of varnish for the information bearing surface 12.

In the case of the second exemplary embodiment according to FIGS. 3 and 4, the compass Z2 has no joint 14 on its leg ZS1 and also no point of separation 15. This embodiment otherwise corresponds to the first embodiment.

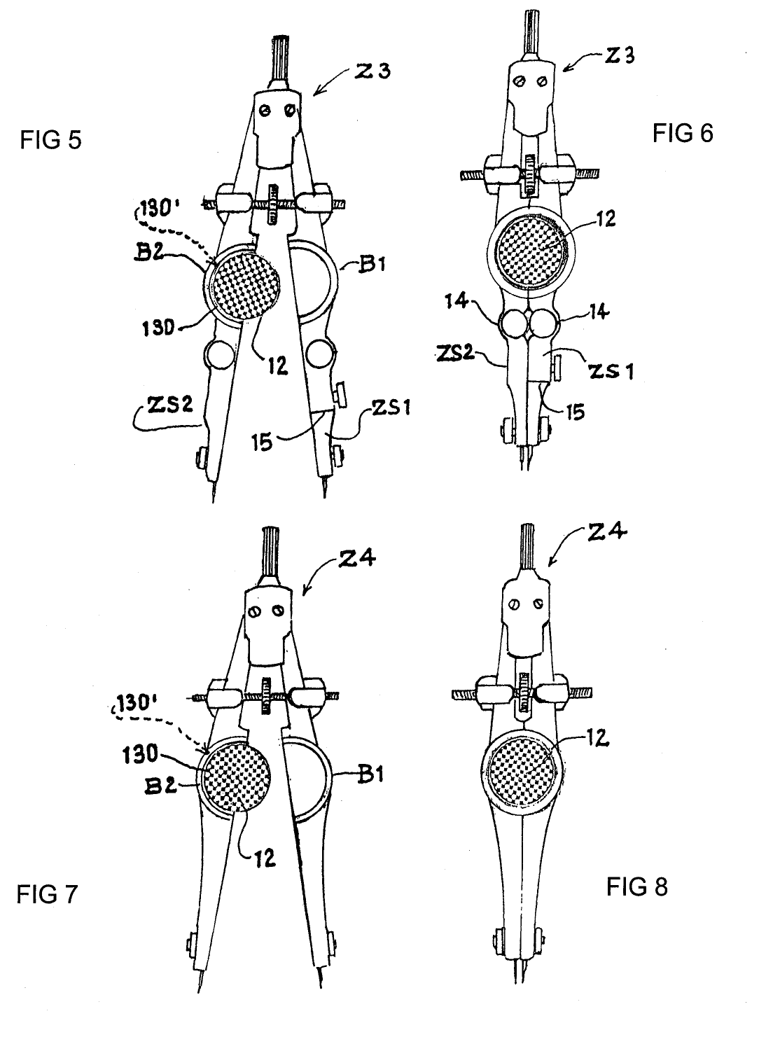

In the third exemplary embodiment according to FIGS. 5 and 6, one respective mounting disk 130, 130′ is attached in a congruent double configuration to each of the front and rear sides of one of the two compass legs ZS2 (or ZS1). In the case of the compass Z3 of FIGS. 5 and 6, a first mounting disk 130 with the information bearing surface 12 can be seen, while a second mounting disk 130′ lies behind the mounting disk 130. Upon closure of the compass Z3, the carrier zone B1 of the compass leg ZS1 passes between the two mounting disks 130, 130′. Otherwise, the structure of this compass Z3 is the same as that of the compass Z1.

In the case of the fourth exemplary embodiment according to FIGS. 7 and 8, the configuration of the information bearing surface 12 and of the mounting disks 130, 130′ is adopted as in FIGS. 5 and 6. The compass Z4 merely has a simpler construction, because the leg joint 14 and the point of separation 15 are omitted.

The compasses illustrated in FIGS. 1 to 8 all have the preferred construction with an adjusting spindle 9. However, the invention also naturally includes structures without an adjusting spindle.

1. A compass, comprising:
two broad sides;
two legs having upper ends and free lower ends;
holders disposed at said free lower ends of said legs for holding refills or styluses;
a leg joint interconnecting said upper ends of said legs for articulation in a spreading plane;
said legs each having a respective carrier zone serving, in a region between said leg joint and said free lower ends of said legs, as a base of an information bearing surface with a greater width in said spreading plane than said legs; and
said information bearing surface being disposed on at least one of said two broad sides and constructed as an undivided surface projecting from one of said legs into vicinity of the other of said legs and permitting opening and closing of said legs without a gap or interspace being formed in said information bearing surface.

2. The compass according to claim 1, which further comprises an adjusting spindle interconnecting and penetrating said legs in vicinity of said leg joint.

3. The compass according to claim 1, wherein said carrier zones are widenings of said legs.

4. The compass according to claim 1, wherein said information bearing surface has a circular shape.

5. The compass according to claim 1, wherein said information bearing surface is a regular polygon.

6. The compass according to claim 5, wherein said regular polygon is selected from the group consisting of a quadrilateral and a hexagon.

7. The compass according to claim 1, wherein said information bearing surface has an elliptical shape.

8. The compass according to claim 3, which further comprises support surfaces in vicinity of said widenings, and mounting disks fastened on said support surfaces, said information bearing surface being attached to one of said mounting disks.

9. The compass according to claim 8, wherein said mounting disks are each attached on a respective one of front and rear sides of one of said two compass legs in a congruent double configuration.

10. The compass according to claim 8, wherein one of said mounting disks is attached to a front side of one of said legs, and the other of said mounting disks is attached to a rear side of the other of said legs.

11. The compass according to claim 8, wherein said information bearing surface is fastened as a printed film on one of said mounting disks.

12. The compass according to claim 8, wherein said information bearing surface is bonded as a printed film on one of said mounting disks.

13. The compass according to claim 8, wherein said information bearing surface has a printed image printed directly onto one of said mounting disks.

14. The compass according to claim 8, wherein said mounting disks are each cast onto a respective one of said compass legs.

15. The compass according to claim 8, wherein said mounting disks are formed of metal.

16. The compass according to claim 15, wherein said metal is diecast zinc.

17. The compass according to claim 8, wherein said mounting disks are formed of imprintable coinage metal and provided with an imprint serving as at least one of information or decoration.

18. The compass according to claim 8, wherein said mounting disks are formed of plastic.

19. The compass according to claim 8, wherein said mounting disks are provided with a coat of varnish for said information bearing surface.
